(19) United States
(12) Patent Application Publication
(10) Pub. No.: US 2019/0107548 A1
(43) Pub. Date: Apr. 11, 2019

(54) SYSTEM AND METHOD FOR LIQUID HANDLING QUALITY ASSURANCE

(71) Applicant: Artel, Inc., Westbrook, ME (US)

(72) Inventors: David L. Bohnsack, Carol Stream, IL (US); Kirby Pilcher, Portland, ME (US); Axel Bjoern Carle, Portland, ME (US); Gregory T. Fischer, Westbrook, ME (US)

(21) Appl. No.: 16/089,778

(22) PCT Filed: Mar. 31, 2017
(86) PCT No.: PCT/US17/25568

§ 371 Date: Sep. 28, 2018

Related U.S. Application Data
(60) Provisional application No. 62/317,103, filed on Apr. 1, 2016.

(51) Int. Cl. G01N 35/00; G06Q 10/08; G06Q 10/00

(52) U.S. Cl. CPC G01N 35/00693; G01N 35/00623; G01N 35/00732; G01N 2035/00811; G06Q 10/20; G01N 2035/00653; G06Q 10/087

(57) ABSTRACT

The present invention is a comprehensive method and related system comprising software, instrumentation, consumables and services (calibration, training, and repair) in a platform system for management of handheld pipettes and automated liquid handling systems (ALBS). The system optimizes confidence in test results, control of liquid handling processes, productivity, and simplicity in operation, by significantly improving the experience in ownership, usage, and service of liquid handling instruments. The system is a turnkey solution integrating multiple technology approaches to provide real-time on-line feedback to the devices and to device users, as well as real-time connection to Electronic Lab Notebooks (ELN), Laboratory Information Management Systems (LEVIS) and training databases.

### CROSS REFERENCE TO RELATED APPLICATION

The present application claims priority in U.S. provisional application Ser. No. 62/317,103, filed Apr. 1, 2016, of the same title and owned by the same applicant. The entire content of the priority application is incorporated herein by reference.

### BACKGROUND OF THE INVENTION

### 1. Field of the Invention

The present invention relates to the field of quality assurance. More specifically, the invention discloses a system and method for management of a multiplicity of liquid handling instruments and the associated artifacts (consumables, such as pipette and ALHS tips, calibration solutions, etc.), data and services in laboratories.

### 2. Description of the Prior Art

Liquid handling is a basic process central to most biological and chemical testing performed in laboratories across numerous commercial and academic enterprises. Liquid handling is the process of acquiring, transporting, and delivering quantifiable volumes of liquid samples. Liquid handling is performed either by human operators with a handheld pipette or by means of Automated Liquid Handling Systems (ALHS) of various types.

Pharmaceutical, biotechnology, diagnostic, clinical, forensic, analytical quality control, academic and other labs have millions of devices, both handheld pipettes and ALHS, for handling samples of liquid. Some labs have a hundred different models and over ten thousand individual pipettes and ALHS that all require optimized methodologies, a record of regular calibration, verification of calibration and regular preventive maintenance to ensure measurement standardization, regulatory compliance, and satisfaction of the demand for quality. Additionally, laboratory personnel are required to maintain records of training and competency in the proper usage and maintenance of devices. For laboratory technologists, directors, scientists, purchasers and metrologists, management of the device records is essential for both accurate test results and regulatory compliance.

What is needed is a system that provides secure and efficient electronic management of liquid handling devices along with data analysis tools so operators can make informed decisions about their population of devices. What is further needed is such a system that gathers device usage and performance data for many devices over long time periods, over many labs, and many operators, and aggregates that data for a more comprehensive understanding of laboratory device capability and usage. The analysis of those aggregated data can be used to benefit each lab manager.

### SUMMARY OF THE INVENTION

The present invention is a system and related method that provide secure and efficient electronic management of liquid handling devices along with data analysis tools so operators can make informed decisions about their population of devices. The system gathers device usage and performance data for many devices over long time periods, over many labs, and many operators, and aggregates that data for a more comprehensive understanding of laboratory device capability and usage. The analysis of those aggregated data can be used to benefit lab managers.

The present invention provides a framework to (1) address the factors critical to customers as they strive to increase productivity and ensure compliance and to (2) provide a competitive advantage to customers and service providers through analysis and processing of consolidated data with an extensible, accessible, and flexible system platform. The system platform includes three main components that address liquid handling quality assurance: Services in the form of process experts and highly-trained operators, Hardware in the form of instrumentation and consumables, and cloud-based Software for real-time data collection, storage, analytics and business intelligence. The platform is configured to actively assist with ensuring uninterrupted supply of all consumables for devices, scheduling/dispatching of service, providing substitute devices, etc. It provides an uninterrupted and sufficient amount of supplies for device calibrations, such as reagents, for example. Scheduled calibration, calibration verification, training and operator assessment events will be used to predict the necessary reagent supplies.

The platform technology includes advanced measurement systems and sensors, advanced process-control analytics, product and process knowledge, multivariate data analysis, and real-time optimization. The platform applies analytics to liquid handling data and makes possible a unique ability for comparative analysis of peer-to-peer-group information to aid the optimization of analytical processes, devices and procedures.

These and other advantages of the present invention will become apparent upon review of the following detailed description, the accompanying drawings and the appended claims.

### BRIEF DESCRIPTION OF THE DRAWINGS

FIG. 1 is a simplified representation of a computing system suitable for carrying out the functions of the present invention as described herein.

FIG. 2 is a table representing the primary modules of the platform system of the present invention.

FIG. 3 is a display of a first screen depiction representing the interface for a user to access the platform system of the present invention.

FIG. 4 is a display of a second screen depiction representing the interface for a user to access the platform system of the present invention.

FIG. 5 is a display of a third screen depiction representing the interface for a user to access the platform system of the present invention.

FIG. 6 is a display of a fourth screen depiction representing the interface for a user to access the platform system of the present invention.

FIG. 7 is a display of a fifth screen depiction representing the interface for a user to access the platform system of the present invention.

FIG. 8 is a display of a sixth screen depiction representing the interface for a user to access the platform system of the present invention.

FIG. 9 is a display of a seventh screen depiction representing the interface for a user to access the platform system of the present invention.

FIG. 10 is a display of an eighth screen depiction representing the interface for a user to access the platform system of the present invention.

FIG. 11 is a display of a ninth screen depiction representing the interface for a user to access the platform system of the present invention.

### DETAILED DESCRIPTION OF THE INVENTION

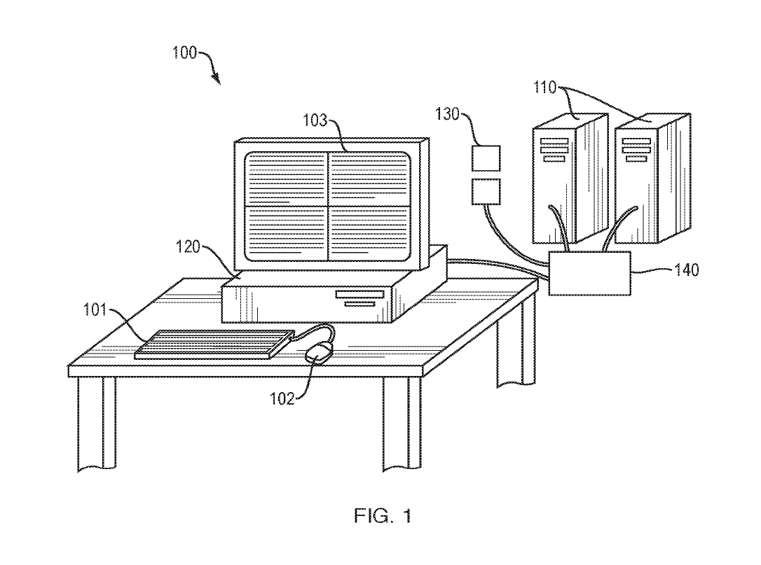

The present invention is a platform system and related method for improving the quality of liquid handling devices and their usage. The platform is embodied in a computing system programmed to perform functional steps associated with the gathering and storing of information for the purpose of accessing it, carrying out analysis based on the information and conducting activities based on the analysis performed. Any type of computing system suitable to store information in the amount of interest and to perform analysis of interest on the information may be employed and is represented generally in FIG. 1. The computer system 100 shown is only one example of a suitable computing environment and is not intended to suggest any limitation as to the scope of use or functionality of the invention. For example, the computer system 100 may be associated with local or remote computing means, such as one or more central computers, such as server 110 in a local area network, a metropolitan area network, a wide area network, or through intranet and internet connections.

The computer system 100 may include one or more discrete computer processor devices, represented by desktop computer 120, for example. Examples of well-known computing devices that may be suitable for use with the invention include, but are not limited to, personal computers, server computers, hand-held or laptop devices, multiprocessor systems, microprocessor-based systems, network PCs, minicomputers, mainframe computers, distributed computing environments that include any of the above systems or devices, and the like. The computer system 100 may include computer devices operated by one or more users, such as through a desktop, laptop, or servers, and/or one or more providers of services corresponding to one or more functions of the invention.

The server 110, the computer processor device 120, or a combination of both may be programmed to include one or more of the functions of the invention system. The database configured to contain and provide information of interest related to the use, management and maintenance of liquid handling devices is represented by Database 130. For the purpose of the description of the present invention, a database is a collection of stored data that are logically related. Although there are different types of databases, and the Database 130 of the present invention may be any of such types, it is preferably a relational database with a relational database management system, comprising tables made up of rows and columns. Data stored in the relational tables are accessed or updated using database queries submitted to the database system.

Database 130 may be associated with the server 110, the computer processor 120, other computing devices, or any combination thereof, and include information related to the use of the invention system. The Database 130 may be associated with a single computing device or a plurality of devices. The Database 130 may be centrally located or it may be distributed locally or widely. The Database 130 is populated and updated with information of the type described herein. All of the devices may be interconnected through one or more signal exchange devices, such as router/switch 140.

The platform system may be described in the general context of computer-executable instructions, such as program modules, being executed by a computer such as the computer system 100. Generally, program modules include routines, programs, objects, components, data structures, etc. that perform particular tasks or implement particular abstract data types. As indicated above, the platform of the present invention may also be practiced in distributed computing environments where tasks are performed by remote processing devices that are linked through a communications network or other data transmission medium. In a distributed computing environment, program function modules and other data may be located in both local and remote computer storage media including memory storage devices.

The computer processor 120 and interactive drives, memory storage devices, databases, including but not limited to the Database 130, and peripherals may be interconnected through one or more computer system buses. The system buses may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The computer system 100 typically includes a variety of computer readable media. Computer readable media can be any available media that can be accessed by computer system 100 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer system 100.

The computer system 100 further includes computer storage media in the form of volatile and/or non-volatile memory such as Read Only Memory (ROM) and Random Access memory (RAM). RAM typically contains data and/or program modules that are accessible to and/or operated on by computer processor 120. That is, RAM may include application programs, such as the functional modules of the system of the present invention, and information in the form of data. The computer system 100 may also include other removable/non-removable, volatile/non-volatile computer storage and access media. For example, the computer system 100 may include a hard disk drive to read from and/or write to non-removable, non-volatile magnetic media, a magnetic disk drive to read to and/or write from a removable, non-volatile magnetic disk, and an optical disk drive to read to and/or write from a removable, non-volatile optical disk, such as a CD-ROM or other optical media. Other removable/non-removable, volatile/non-volatile computer storage media that can be used in the computer system 100 to perform the functional steps associated with the system and method of the present invention include, but are not limited to, magnetic tape cassettes, flash memory cards, digital versatile disks, digital video tape, solid state RAM, solid state ROM, and the like.

The drives and their associated computer storage media described above provide storage of computer readable instructions, data structures, program modules and other data for the computer processor 120. A user may enter commands and information into the computer processor 120 through input devices such as a keyboard 101 and a pointing device 102, commonly referred to as a mouse, trackball or touch pad. Other input devices (not shown) may include a microphone, joystick, game pad, satellite dish, scanner, or the like. These and other input devices are connected to the computer processor 120 through the system bus, or other bus structures, such as a parallel port, game port or a universal serial bus (USB), but is not limited thereto. A monitor 103 or other type of display device is also connected to the computer processor 120 through the system bus or other bus arrangement. In addition to the monitor 103, the computer processor 120 may be connected to other peripheral output devices, such as printers (not shown). Commands and information may be entered by one or more users any one or more of whom may be located in the same or different locations. Commands and information may be entered at designated or random times.

The computer processor 120 may be configured and arranged to perform functions and steps embodied in computer instructions stored and accessed in any one or more of the manners described. The functions and steps, such as the functions and steps of the implementation of the platform and its use in regard to the present invention, individually or in combination, may be implemented as a computer program product tangibly as computer-readable signals on a computer-readable medium, such as any one or more of the computer-readable media described. Such computer program product may include computer-readable signals tangibly embodied on the computer-readable medium, where such signals define instructions, for example, as part of one or more programs that, as a result of being executed by the computer processor 120, instruct the computer processor 120 to perform one or more processes or acts described herein, and/or various examples, variations and combinations thereof. Such instructions may be written in any of a plurality of programming languages, for example, WL, Java, Visual Basic, C, or C++, Pascal, Basic, COBOL, and the like, or any of a variety of combinations thereof Information entry may be effected using such programming languages as well as other applications including for example and in no way limited thereto, database programs ACCESS and DB2. The computer-readable medium on which such instructions are stored may reside on one or more of the components described above and may be distributed across one or more such components.

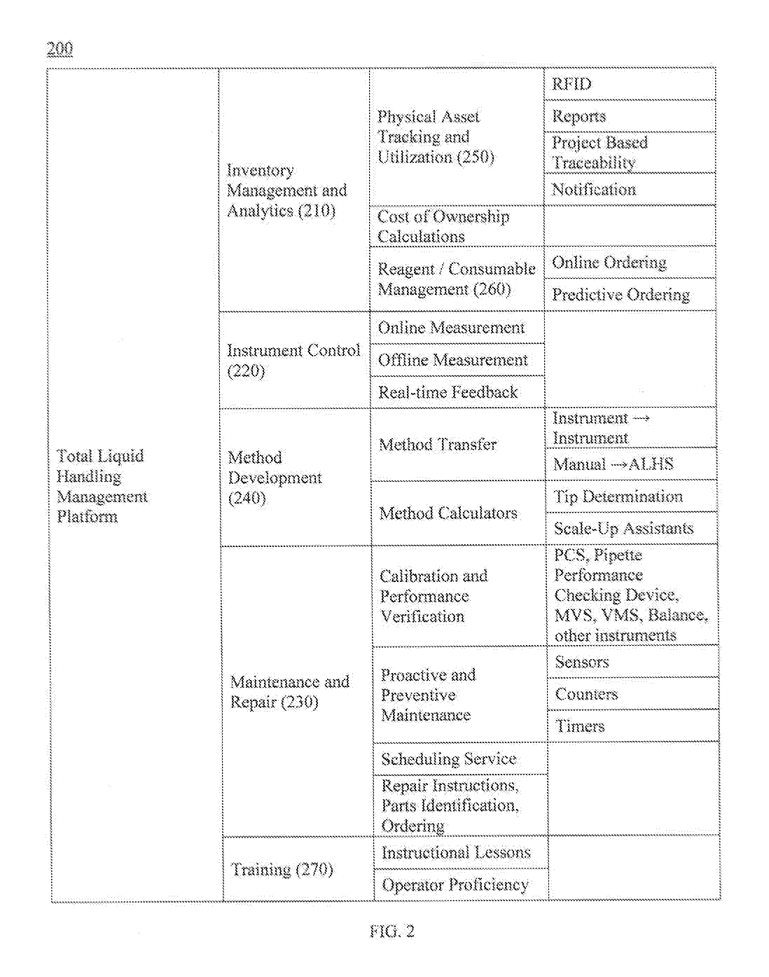

With reference to FIG. 2, a total liquid handling management platform system 200 of the present invention includes a plurality of modules, each of which provides a function of the system 200. The system 200 includes an inventory management and analytics module 210 operable on the computing system 100 in communication with the database 130. It is configured through programming to manage an inventory of one or more new and used liquid handlers that are characterized by selectable information stored in the database 130 and to gather information associated with the liquid handlers, recognize patterns of performance, analyze patterns of performance and develop information from that analysis to estimate cost of operations and to assess the efficiency of processes and operations. The system also includes an instrument control module 220 operable by the computing system 100 in communication with the database 130 and configured through programming to transmit and receive information associated with operation of the one or more liquid handlers. The system further includes a maintenance module 230 operable by the computing system 100 in communication with the database 130. The maintenance module 230 is also in communication with the instrument control module 220 and one or more sensors coupled to the one or more liquid handlers, wherein the maintenance module 230 is configured through programming to carry out calibration of the one or more liquid handlers.

The system further optional includes a method module 240 operable by the computing system 100 and configured through programming to enable liquid handler to liquid handler exchanges, most suitable tip determination and scale-up assistance. The inventory management module 210 includes a physical asset tracking and utilization submodule 250 and a reagents and consumables submodule 260, as described further herein. The instrument control module 220 is configured to conduct online and offline liquid handler measurements with feedback to the database 130 and the inventory management module 210. The maintenance module 230 is configured to conduct calibration and performance verification, proactive and preventive maintenance, scheduling, repair instructions and parts identification. The system 200 further includes a training module 270 operable by the computing system 100 in communication with the database 130. It is configured through programming to supply instructional lessons remotely through internet access or locally through the keyboard 101, for example, on liquid handler operation and to conducting testing of liquid handler operator proficiency. It is to be noted that the one or more liquid handlers subject of quality assurance through use of the system 200 may be any combination of automated liquid handling systems and pipettes. The system 200 optionally includes an inventory of liquid handlers, reagents and consumables, wherein information associated with the inventory is maintained in the database 130.

The system 200 performs Inventory Management with physical asset tracking and utilization via RFID, reports and notifications. Inventory Management also includes Total Cost of Ownership calculations and predictive on-line ordering of reagents and consumables, as well as provision of replacement instruments and spare parts. The instrument control is provided through on-line measurement, off-line measurement and real-time feedback. The system 200 uses machine learning techniques such as pattern recognition to make predictions and optimize performance of liquid delivery devices. Advanced data analytics of the inventory management and analytics module 210 are employed to develop algorithms for reliable and repeatable decisions and results. The algorithms are designed to reveal hidden insights by learning from historical relationships and trends in the data. The system 200 optionally provides Method Development including Method Transfer between instruments of the same type and between manual and automated liquid delivery devices. Method Development also includes Method Calculators for such parameters as suitable tip determinations and for scaling-up of processes.

The system 200 is used as part of a method of improving quality assurance for liquid handlers. The method is implemented at least in part by a computing system configured to carry out executable instructions using computer-implemented functions to maintain one or more liquid handlers. It includes the step of establishing and updating a database of information including information associated with an inventory of new and used liquid handlers and provides for managing the inventory of new and used liquid handlers. The method of the invention further includes transmitting and receiving information to and from the one or more liquid handlers and the database associated with operation of the one or more liquid handlers, calibrating the one or more liquid handlers and transmitting to the database information associated with the calibration.

The method of the present invention enables the provision of services for improved liquid handler quality assurance and maintenance. The Services provided through use of the system 200 for Maintenance and Repair include Calibration and Calibration Verification of liquid delivery devices with a variety of hardware including photometric and gravimetric instrumentation. Through the use of a variety of on-board sensors, counters and timers, the system 200 collects usage data and device diagnostic and offers proactive and reactive maintenance management. Proactively, the system 200 monitors the liquid delivery devices, detects performance concerns and dispatches the appropriate response without further initiation. Reactively, the system 200 notifies the end user that action is needed, and provides a means for the user to initiate the appropriate response. The database 130 includes a library of repair instructions and parts identification diagrams as well as the means to order those parts using predictive algorithms so that supplies are maintained.

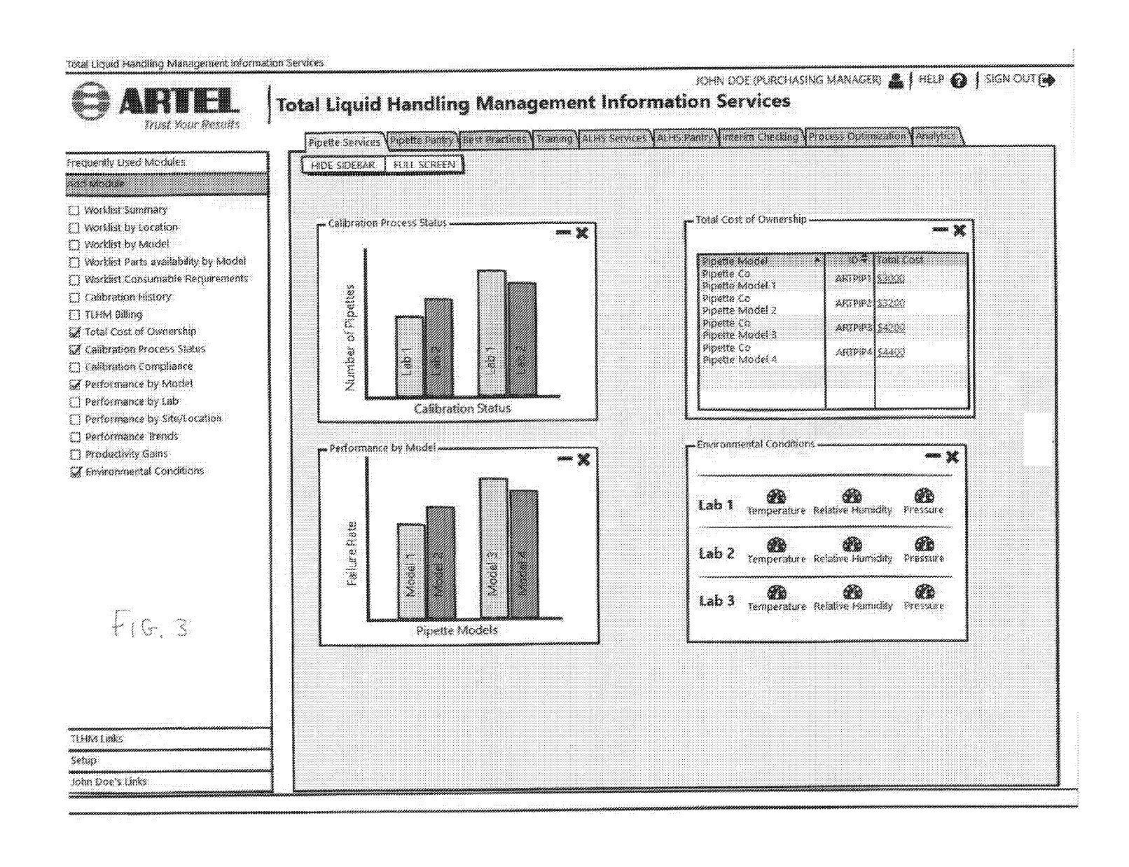

The initial system access display represented in FIG. 3 presents a user of the system 200 with a set of choices for entry into the system 200, which, when activated, enable the user to choose from an array of paths to view and input liquid handler device related information. The Graphical User Interface (GUI) of the initial screen includes on the left side a set of function secondary submodules that may be chosen for viewing on the primary viewing area with respect to the primary functional submodule selected. Across the top of the screen is a tab set for accessing those primary functional submodules of the system 200. The primary submodules shown for selection include: Pipette Services, Pipette Pantry, Best Practices, Training, ALHS Services, ALHS Pantry, Interim Checking, Process Optimization and Analytics, all of which are associated with the primary modules 210-240 listed herein, as well as optional modules 250 and 260. The primary viewing area of the screen depicts liquid handling device information associated with the particular secondary submodule tabs from the left side selected. For FIG. 3, the primary submodule tab selected is the Pipette Services tab. It can be seen that information available and editable includes Calibration Process Status, Performance by Model, Total Cost of Ownership and Environmental Conditions as chosen from the secondary submodule viewing options. More or less information or different information may be displayed and adjusted pursuant to the interests of the lab manager responsible for the liquid handling devices under control.

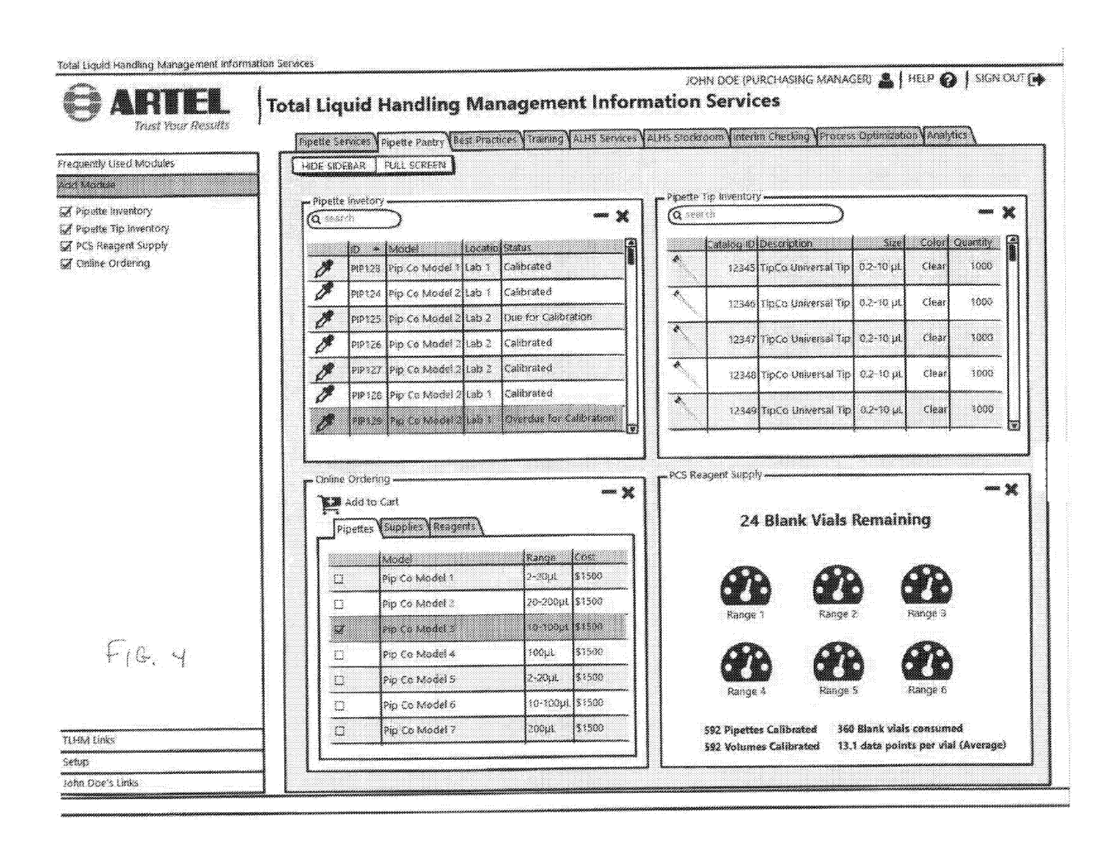

FIG. 4 illustrates a screen that is displayed to the user on the GUI when the Pipette Pantry primary submodule tab is selected. The Pipette Pantry submodule provides the user with information regarding the inventory of components associated with the liquid handling devices managed by the user. The information that can be viewed and edited in this example of such information includes secondary submodules Pipette Inventory, Pipette Tip Inventory, Online Ordering and Reagent Supply. Other materials may be included in the Pipette Pantry by including additional submodules.

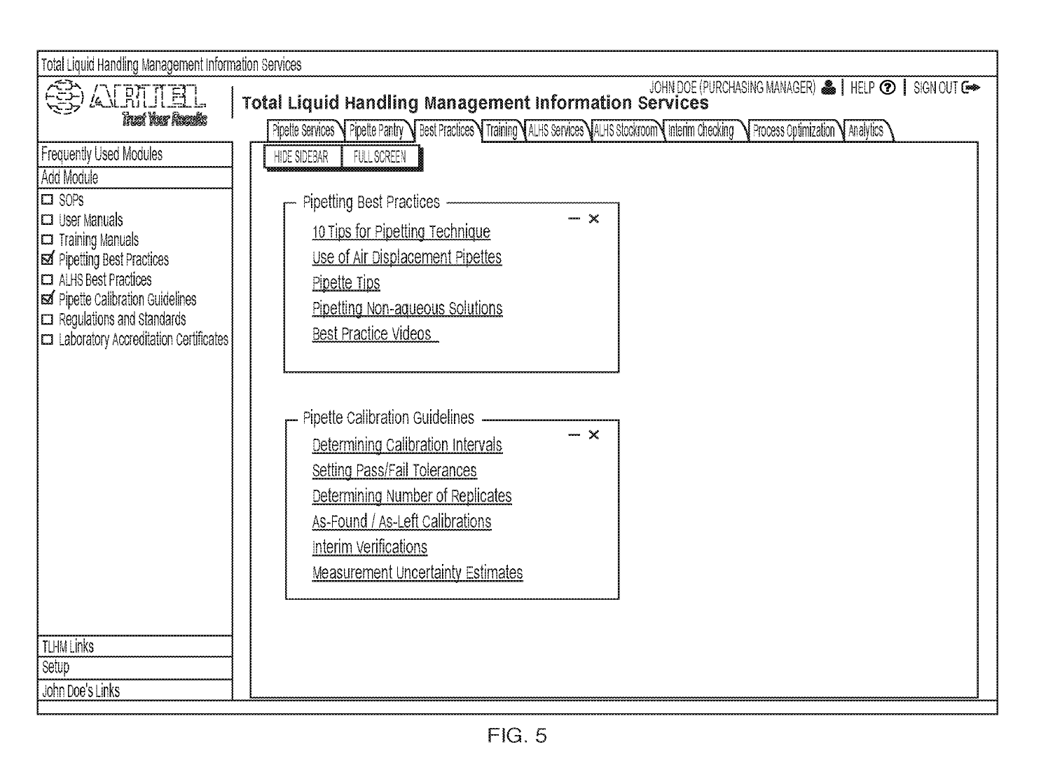

FIG. 5 illustrates a screen that is displayed to the user on the GUI when the Best Practices primary submodule tab is selected. The Best Practices submodule enables the user to select and view or select and edit information regarding optimal pipette and ALHS configurations, components and usage. The information that can be viewed and edited in this example of such information includes secondary submodules Pipette Best Practices and Pipette Calibration Guidelines. Other information may be added or modified.

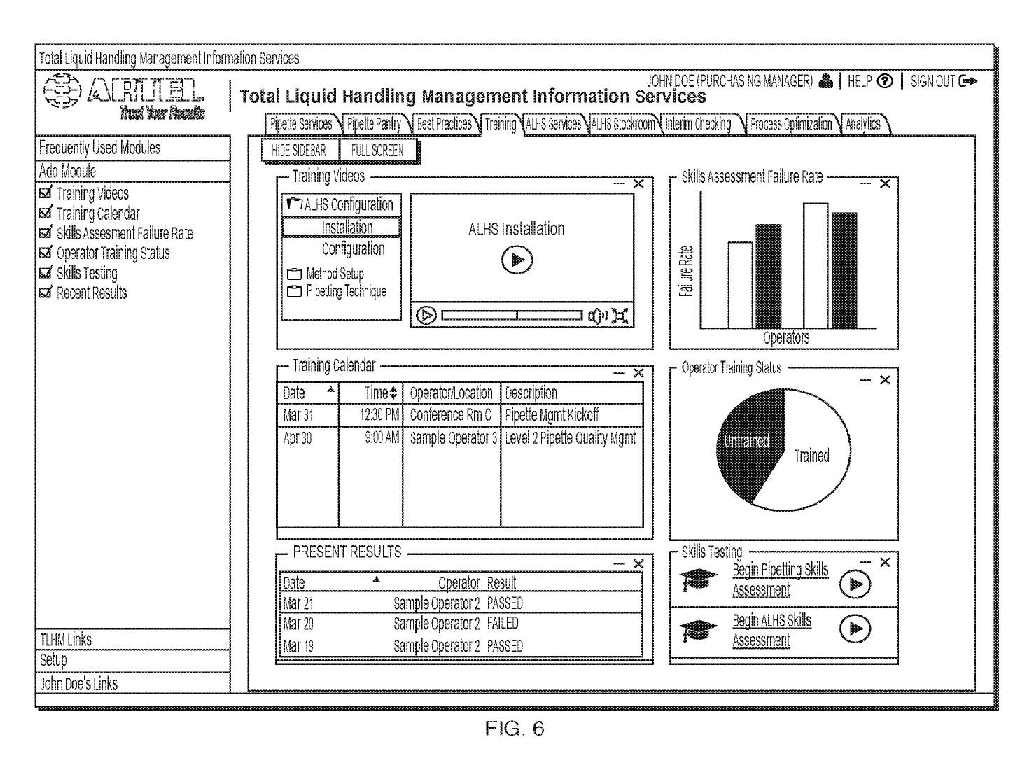

FIG. 6 illustrates a screen that is displayed to the user on the GUI when the Training primary submodule tab is selected. The Training submodule enables the user to select and view or select and edit information, including video information, regarding operation and configuration of liquid handling devices, as well as information regarding evaluation of operators of equipment associated with liquid handler use and calibration. It can also be used to train operators and assess their competence. The information that can be viewed and edited in this example of such information includes secondary submodules Training Videos, Skills Assessment Failure Rate, Training Calendar, Operator Training Status, Recent Results and Skills Testing. Other information may be added or modified.

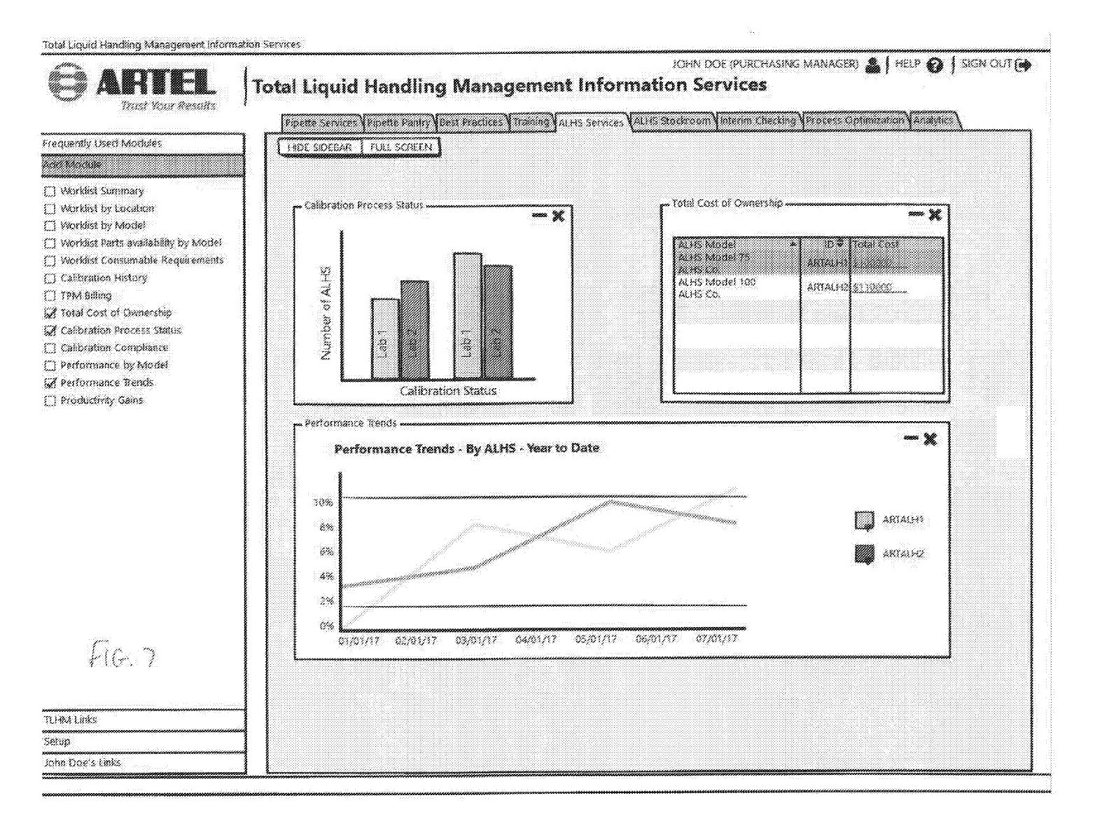

FIG. 7 illustrates a screen that is displayed to the user on the GUI when the ALHS Services primary submodule tab is selected. The ALHS Services submodule enables the user to select and view or select and edit information regarding operation and configuration of ALHS in particular. The information that can be viewed and edited in this example of such information includes secondary submodules Calibration Process Status, Total Cost of Ownership and Performance Trends. Other information may be added or modified.

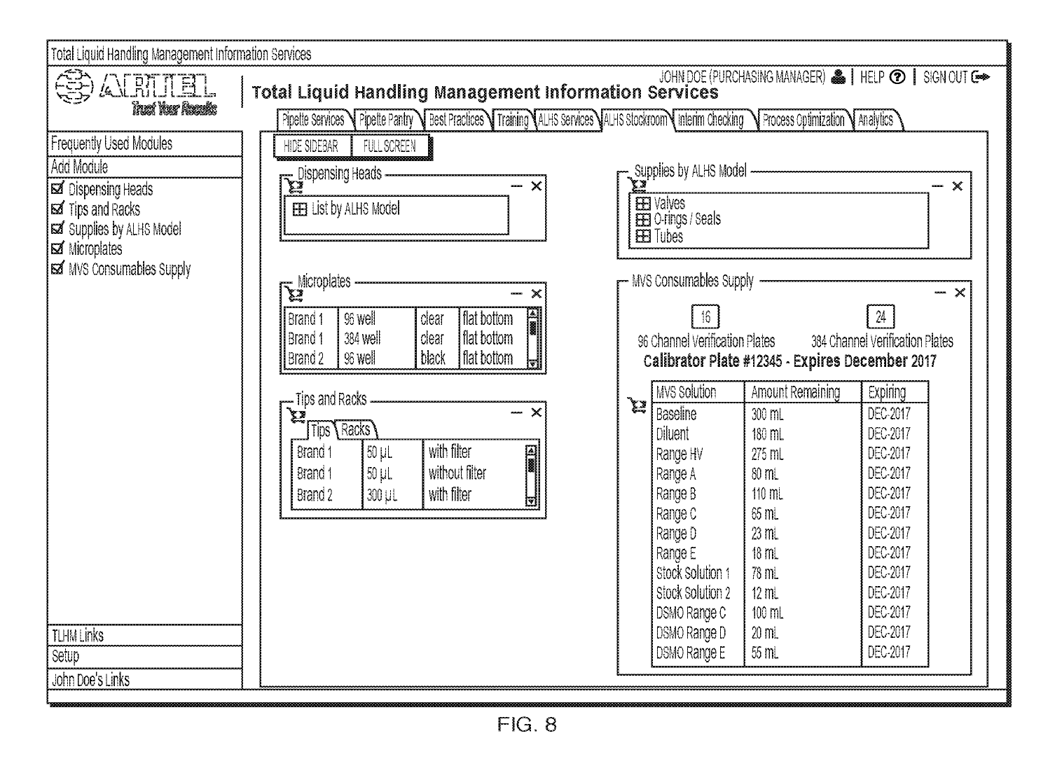

FIG. 8 illustrates a screen that is displayed to the user on the GUI when the ALHS Stockroom primary submodule tab is selected. The ALHS Stockroom submodule enables the user to select and view or select and edit information regarding supplies available for use in ALHS operations. The information that can be viewed and edited in this example of such information includes secondary submodules Dispensing Heads, Tips and Racks, Supplies by ALHS Model, Microplates and Reagent Supply. Other information may be added or modified.

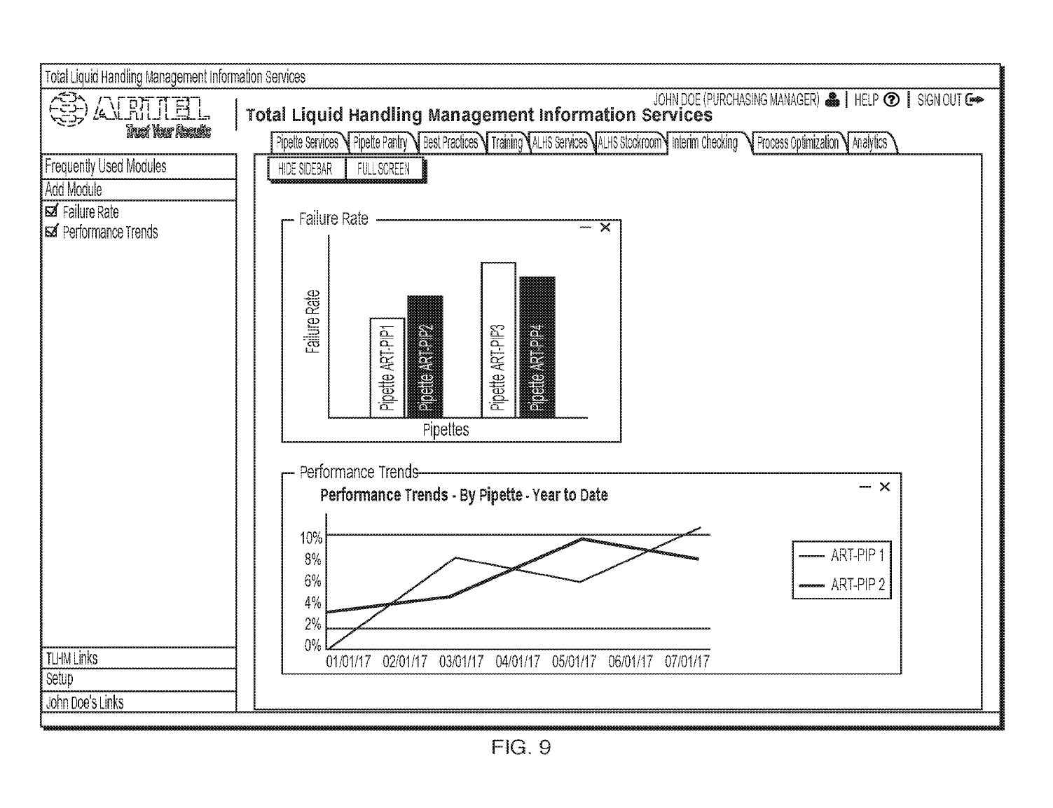

FIG. 9 illustrates a screen that is displayed to the user on the GUI when the Interim Checking primary submodule tab is selected. The Interim Checking submodule enables the user to select and view or select and edit information regarding the operation of liquid handling devices during the course of their deployment in service. The information that can be viewed and edited in this example of such information includes secondary submodules Performance Trend and Failure Rate. Other information may be added or modified.

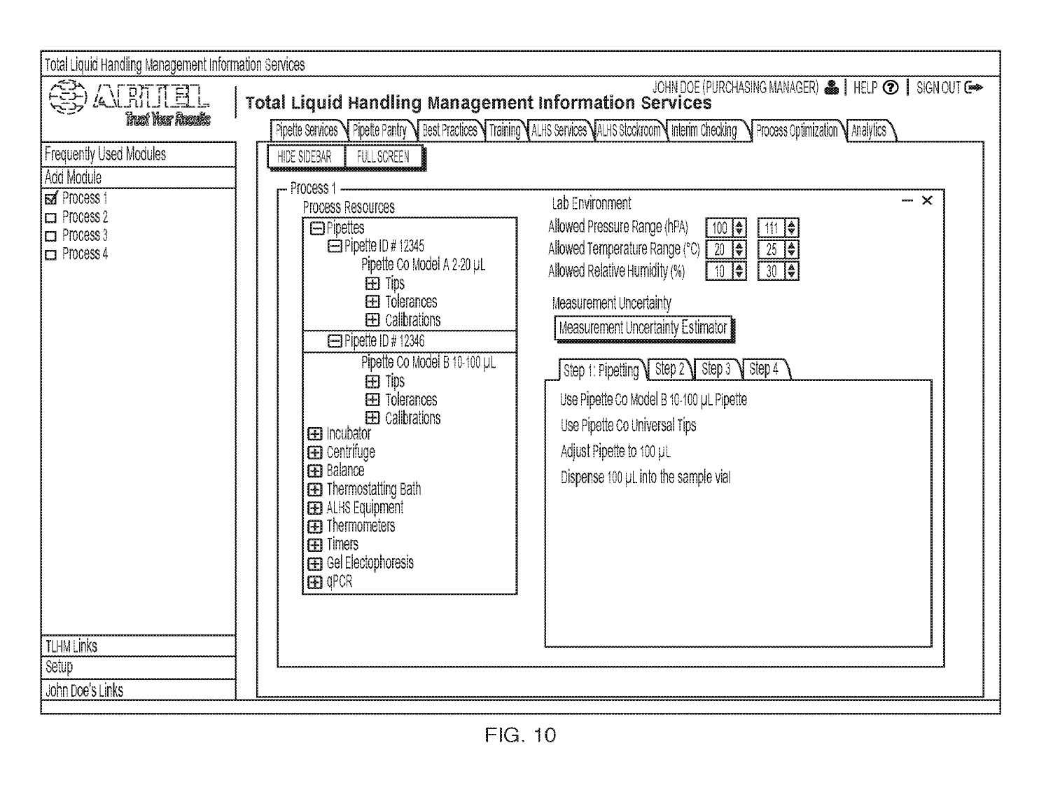

FIG. 10 illustrates a screen that is displayed to the user on the GUI when the Process Optimization primary submodule tab is selected. The Process Optimization submodule enables the user to select and view or select and edit information regarding components and operation of equipment to optimize use of that equipment in providing quality assurance in the function of the calibration activity undertaken with that equipment. Functions enabling estimation of stepwise or overall measurement uncertainties are provided. The information that can be viewed and edited in this example of such information includes secondary submodule Process Resources. Other information may be added or modified.

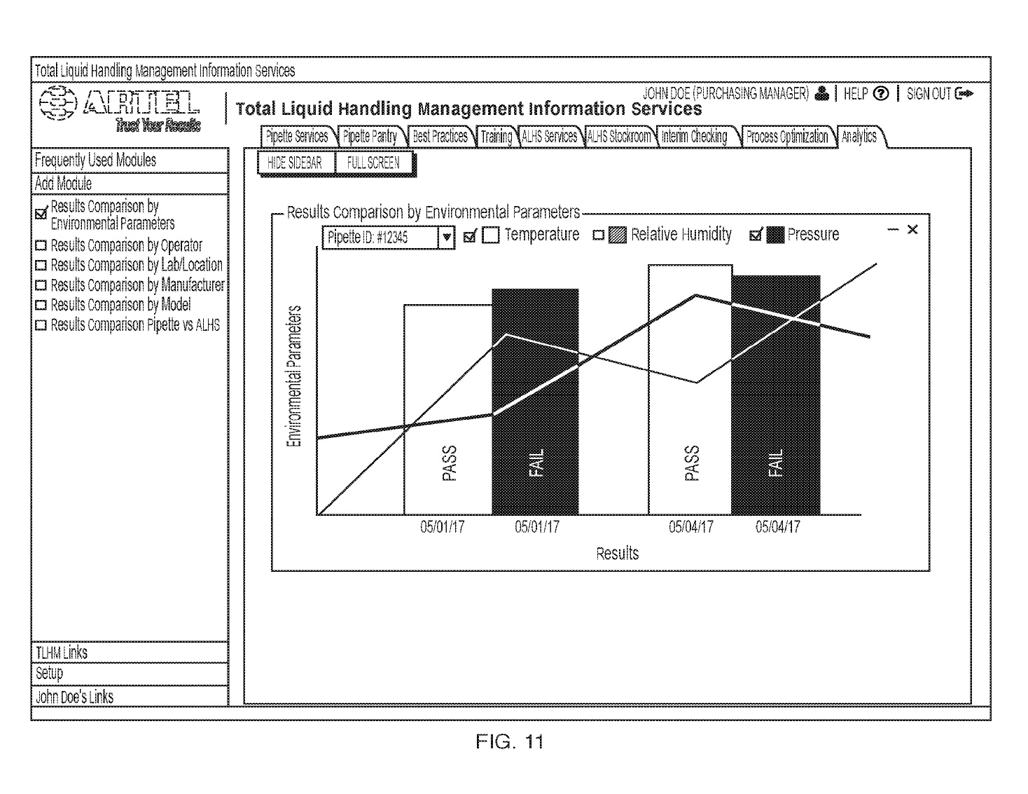

FIG. 11 illustrates a screen that is displayed to the user on the GUI when the Analytics primary submodule tab is selected. The Analytics submodule enables the user to select and view information about conditions of operation of liquid handling devices and the impact of such conditions on accuracy, repeatability, and reliability of the equipment used, among other capabilities. The information that can be viewed and edited in this example of such information includes secondary submodule Results Comparison by Environmental Parameters. Other information may be added or modified. The Analytics submodule is configured to recognize patterns of performance of the one or more liquid handlers, analyze patterns of performance and develop information from that analysis to estimate cost of operations and to assess the efficiency of processes and operations associated with the one or more liquid handlers.

A detailed description of example components of the platform system 200 and their configuration is further provided herein. It is to be understood that this is an example of the functionality of the system 200 and is not limited to the specific implementation described.

The services offered through use of the system 200 include a collection of training capabilities available on-line in real time as well as in-person training by experts in liquid delivery quality assurance. On-line services include both instructional lessons and operator proficiency/competency assessment. The system 200 may optionally be supplemented with on-site services with specially-trained operators, off-site services at certified facilities, and best-practices consulting that span Internet, off-site and on-site access to experts. Some of the services may be optional with a subscription to a core set of services. On-site services may include calibration, calibration verification and preventive maintenance of pipettes and ALHS. Using trained technicians, the process can be fast and efficient, error free and fully traceable to national and international standards. Off-site services for pipettes include preventive maintenance, repair, and calibration. Proper pipette and ALHS repair requires establishing explicit maintenance and repair processes designed to ensure optimal function. The service can successfully repair most issues affecting malfunctioning pipettes for less than the cost of a replacement pipette.

The stockroom services represented by the Pipette Pantry and ALHS Stockroom primary submodules provide pipettes and ALHS parts on a temporary loan while regular pipettes are under calibration, calibration verification and maintenance procedures. The pipette and ALHS calibration and repair service is ISO accredited to ISO 17025 and compliant to ISO 8655, ASTM E1154, and ISO IWA 15, so all levels of service include standardized quality, repair, and preventive maintenance. The service relies on highly-trained staff of skilled and knowledgeable service technicians to perform the proper service for all pipette and ALHS brands and models. Regular calibration, calibration verification, preventive maintenance, and proper repair are required when a measurement device is relied upon daily for accuracy and precision. Because movable parts wear over time, it is vital to detect and remediate performance issues before they occur. Malfunctioning liquid handling devices will produce measurements that deviate beyond the tolerance range for the procedure in which the pipettes or ALHS are used. Those procedures will produce unreliable results. The Interim Checking primary submodule may be used to minimize that unreliability.

As-found testing is conducted at the start of every test cycle. All testing includes not only tolerance limits but also action limits inside of the tolerance limits. When the statistical measures exceed the action limits, preventive maintenance actions are recommended. The goal is to identify pipettes and ALHS that are still within tolerance, but which would benefit from early preventive maintenance (PM) and thereby to prevent asfound failures by highlighting devices that are close to being out of service. All PM actions are recorded and as-left testing is conducted. When the tolerance limits are exceeded, every pipette or ALHS repair starts with a detailed preventive maintenance. This includes disassembling the pipette so that it may be cleaned inside and out, polishing and re-lubricating all pistons, and refurbishing and replacing parts as needed, so that the pipette performs like new. Preventive maintenance and proper repair reduces the downstream risk of liquid delivery error and measurement deviations. Technicians are trained to provide repair and preventative maintenance services with every pipette and ALHS calibration.

On-site service may include using a comprehensive verification system, such as the Multichannel Verification System (MVS®) available from Artel, Inc., of Westbrook, Me., US, for optimization of ALHS, known as Liquid Handler Performance Verification Service. ALHS quality assurance may be provided with a customized service to verify that all ALHS are performing optimally. It is to be noted that other on-site services may be included as an aspect of this feature of the system 200. For example, the Pipette Calibration System (PCS®) available from Artel is configured to provide such on-site service with respect to pipette calibration. The service may include one or more of the following:
Experts to take care of the specialized and critical task of Performance Qualification (PQ) including standardized and customized volume transfer assessment for most makes and models of ALHS.
Documented performance results that are traceable to the International System of Units (SI) through calibration standards maintained by the National Institute of Standards and Technology (NIST, USA) and National Physical Laboratory (NPL, UK).
Results from a standardized volume verification system, such as the Artel MVS, to ensure repeatability of liquid handler methods between laboratories or locations.
Tip-by-tip and well-by-well statistics for volumes transferred into 96-well or 384-well microtiter plates including precision and trueness assessment for all tips, according to ISO IWA 15.
Determination of dilution step accuracy for dilutions up to at least 1:2048 of the starting material
Analysis of non-aqueous solution volume transfers
Volume transfer performance assessment for scheduled or periodic services for liquid handlers in multiple locations
Site acceptance testing of select new equipment
Consultation and guidance in writing operating procedures and methods for assays
Compliance with internal SOPs and documentation procedures
Thorough performance validation of equipment after repair and maintenance
Real-time assistance in method optimization to ensure assay data integrity
Liquid handling process optimization
Side-by-side comparison of dispensed volumes between different automated methods and different liquid handlers (method-to-method or device-to-device comparisons)
Development and evaluation of new volume transfer strategies to show cause-and-effect volume-based measurements after manipulations to method parameters and liquid class settings including, but not limited to:
Reverse mode pipetting vs. forward mode
Air gap use
Tip touches
Dispense rates/heights
Wet dispense vs. dry dispense

Through partnerships with ALHS manufacturers, the service may further provide:
Expedited ordering and delivery of replacement parts
OQ and PQ validation at the customer site
Instrument performance certification to ISO IWA 15
Preventive maintenance service
Optimization training

On-site and off-site training services may be provided through the Training primary submodule with programs for pipetting technique proficiency certification, pipette quality management, real-time performance monitoring, and ALHS optimization. The system 200 may include multimedia online training available on the Internet both on demand through subscription services and through scheduled webinars. These trainings may be complemented with hands-on data collected in the trainee's laboratory, through networked instruments (e.g., PCS, MVS, and others). Course attendees may log on to the training sessions and managers may have access to the results and tools to observe consistent improvement in the skill level of the technicians. Completed training may result in certification and/or issuance of continuing education credits. Training services may be ordered on-line through the system's web interface.

Measurements of volume dispensed per well in a microplate are used to estimate the trueness and precision of an ALHS. For purposes of describing this invention, the term “accuracy” may be used from time to time to have not only its ordinary meaning but also to incorporate the concept of trueness and precision as known by those skilled in the art of this invention. Ensuing actions are taken, usually in the programming associated with Interim Checking and Process Optimization primary submodules of the system 200. Often, expert experience plays a major role in optimizing. For instance, the on-site engineers who use robots associated with liquid handler operations can make adjustments to the variables based on the data acquired. Liquid class settings can be manipulated as can tip types and sizes, syringe sizes, additional air gaps, tip touches, etc. An adjust-and-measure iterative process is conducted until the performance meets specifications.

The programming employed to implement services through the system 200 includes software to help optimize some ALHS based on, including, but not limited to a linear (y=mx+b) calibration process. Volume measurement results are used to approximate the linear regression and the resulting slope and offsets are substituted into the ALHS software and the process is repeated as needed until the tolerances are achieved and the ALHS is optimized. The software includes on-line optimization routines, with regular test results to provide optimized parameters to maintain peak performance. These tests can be discrete tests with test solutions, or in-line tests using plates filled with customer samples. In cases where the ALHS software can accept external control, real-time interaction between the system software and the ALHS software can provide automatic optimization or force an interruption of the process if the instrument performs outside of specified tolerances.

Electronic handheld pipettes can be adjusted by the system software based on results from discrete calibration or other volume verification tests such as interim performance verifications. Calibrations, adjustments, diagnostic routines, or a functional lock can be activated on electronic pipettes by wireless protocol or through docking station in cases where external control is authorized by the manufacturer. All test results and adjustment cycles are recorded and stored by the Software platform, and are available for performance-analytical processes as well as direct reporting and correlation to experimental or assay results. A handheld smart pipette continuously monitors its performance and adjusts dispensing parameters accordingly, so that it always performs within specified tolerances. The smart pipette is also aware of its various users and adjusts its performance in real-time based on each user's particular peculiarities of operation. The smart pipette can be disabled for unqualified, disallowed or inappropriate users or after significant events such as a drop, contamination of the piston, or use outside of calibration or verification intervals. The Training primary submodule is configured to establish operator qualification and certification and, thereby, grant operator permissions of the smart pipette.

The Best Practices primary submodule can be accessed through on-site and off-site consulting. Experts in the field of liquid handling quality assurance may be made available and provide in conjunction with operation of the system 200 guidance with, for example, metrology, calibration, calibration verification and interim performance verification requirements such as test frequencies, volumes to test, acceptable performance tolerance limits, number of data points, statistical evaluation methods, lab environmental requirements and their impact on measurements, as well as compliance to relevant standards, regulations, and guidelines. Other such services may be added as needed for the particular equipment employed and use of that equipment. Expert consulting can also optionally include guidance on establishing measurement uncertainties for overall laboratory processes involving liquid handling or individual steps thereof, standard operating procedures, quality control recommendations, work-flow and process optimization, as well as operator training and competency assessments, and record keeping. Best practices in risk assessment and risk management of processes involving liquid handling will be applied to devise test methods and protocols, as well as use parameters for pipettes and ALHS. The system 200 provides easy access to the support of experts in best practices for liquid handling and method transfer concerns, who will provide expertise based on current business practices and the results of aggregate data and business intelligence in the field of liquid handling.

Optional services available through use of the system 200 may extend to logistics support with guidance and experts to integrate inventory control, scheduling, pick-up and drop-off service, documentation management, and pipette/ALHS stockroom management.

Optional software integration services may be included in the method of the present invention through provision of experts to aid the technology infrastructure staff in the customization, management, and validation of the system 200 and the database 130 in particular. The system 200 provides access to software device drivers and updates. Integration and interface with LIMS and other enterprise software (SAP, Blue Mountain, etc.) may be configured for integration as needed by particular users of the system 200.

The system 200 further optionally includes one or more single-channel photometric instruments with reagents for calibration, calibration verification, and interim performance verification of pipettes. One or more multichannel photometric instruments with reagents may be included for interim verification of ALHS, handheld multichannel pipettes, as well as semi-automated multichannel liquid handling devices. Various models of single- and multichannel-volume measurement instruments with different performance characteristics, depending on their intended use, can be connected to and recognized by the system 200. Environmental monitors (measuring temperature, relative humidity, barometric pressure) placed in the rooms of pipette calibration, pipette use, and on the work surface (“deck”) of ALHS allows correlation of volume measurement data with environmental parameters through one or more of the Interim Checking, Process Optimization and Analytics primary submodules.

Reagent use can be monitored and that information can be integrated with purchasing databases to generate purchase orders, exchange financial information and facilitate predictive or ad hoc online ordering. Additional support for gravimetry for calibration and calibration verification of pipettes and ALHS may be provided through the system 200. Gravimetry requires extensive setup with environmental controls and monitoring, calibration procedures, and work-surface requirements. Supplemental equipment such as devices applying a vacuum to pipette tips which are mounted to a pipette or ALHS dispense head can also be connected to the system for quick checks of seals and O-rings of the liquid handling device.

The system 200 includes through the Pipette Pantry and ALHS Stockroom primary submodules a stockroom that offers everything device operators might need during the normal use. The stockroom has an inventory of calibrated pipettes of various sizes available on loan or through the pipette lease program. The stockroom guarantees 100% up-time for pipettes. Any pipette needed is always available. Along with the pipettes, the tips supply service assures the correct high-quality tips are always available.

The stockroom also offers management of spare parts for devices including O-rings, lubrication supplies, springs, seals and seal holders, shafts, pistons, batteries and chargers, tip cones, tip holders and tip ejectors, maintenance and service kits, racks, etc. For ALHS, the stockroom may be configured to include additional dispense heads or liquid transfer modules (in whole or parts thereof), gantries, liquid lines, pumps, motors, seals, O-rings, valves, sensors, grippers, racks, and other mechanical parts to enable immediate repair and return to service for maximizing the ALHSs' up-time, in addition to tips, tubes, microplates and other common consumables. The stockroom assures everything needed for calibration, calibration verification, and preventive maintenance is available, including gloves, hair covers, wipes, calibration reagents, transfer pipettes, aliquot containers, lab coats, and uniforms. The system 200 can be configured to monitor the stock and create orders for consumables and supplies as-needed in real-time.

The system 200 as configured is based on a software foundation utilizing the Web Services method, designed to support interoperable machine-to-machine interaction over a network. The system 200 is an Application Services Provider (ASP), with software using networks including the Internet as the mechanism to deliver and manage the service. Other specific forms of software for programming the modules described may be employed as previously noted. The software acquires and aggregates data from most any source to support the ownership, service and usage of all types of liquid-handling devices. The software includes a database for management of the inventory of devices based on machine-readable technology such as bar codes and radio frequency identification (RFID) tags. The database 130 also includes laboratory personnel information for the purpose of training, competency assessments, and for active use permissions of appropriately enabled devices (smart pipettes, electronic pipettes, and ALHS).

The software presents liquid handling information in an efficient-to-access and easy-to-use dashboard interface as depicted in FIGS. 3-11, with a suite of tools that give quick, consistent overviews on cost-of-ownership, availability or downtime rate, performance, quality, calibration compliance, repair logistics, the traceability of the device population, as well as the training, certification and competency assessment status of laboratory staff members. The dashboard features easy drill-down analysis of details of the liquid-handling-device population. The data may be viewed by sorting and filtering with standard data-viewing tools. With an Internet connection, the software delivers enriched information content. The software aggregates data from all sources, applies analytical methods, and reports on the results. The comparison of a customer's methods and results to industry averages is particularly useful, actionable insight for guiding risk assessments and protocol adjustments. The software also allows for adding various Web content modules to the pages, including, news feeds, forums, images, HTML, and script objects.

The software includes applications for mobile devices and laptop computers connected to or disconnected from a network. As previously noted, the software can continue to reside entirely on one computer or it can be synchronized with a network server when the connection becomes available at a later time. The software may be packaged as a black-box solution where the customer buys hardware from the supplier preconfigured with server stack and application and drop it into place on their network. The stand-alone software provides traditional reporting. With a network connection to a server the Software adds Online Analytical Processing or OLAP, scorecards, pattern recognition, and data analytics, mining, and exploration. There are tools for grouping and sorting across all device and laboratory parameters, including operator activities, over time and over calculated values to discover patterns and the tools to apply these patterns to business operations. There are tools based on machine learning for predictive insight for better device management and better business decisions in virtually any liquid-handling environment. Predictive insight provides relevant information about or related to the topic of interest in real-time. The software through the Analytics primary submodule provides insights including an estimate of the total cost of ownership for devices, efficiency of laboratory operations, and utilizes proactive and predictive reporting on experimental design approaches to develop insights for all liquid handling processes, thus improving productivity.

Reports are available in real-time on the dashboard or via e-mail, SMS and other active notification methods. The software begins with pre-configured, customizable views for each of the various stakeholders in pipette and ALHS management, including device operators and managers in laboratories, QA, QC, IT, purchasing, materials management, and metrology, as well as for calibration services. The software includes built-in protocols for training and qualification of device operators. Detailed reporting, comparative and predictive analytics will be available to determine a lab's operational performance. Other examples of such protocols include:
Protocols specific for qualification of operators
Require passing qualification test before access to devices
Control device software based on qualifications level
Control access to calibration verification equipment based on training completion
Require periodic refresher training
Online training tutorials

Expert assistance built into the software helps the lab manager:
Determine the overall measurement uncertainty of liquid delivery in the lab based on the actual performance of devices in the lab over time and to compare that measurement uncertainty to other labs across an organization or among peers.
Calculate the probability of results falling outside of desired tolerances based on historic data. This would include not only the uncertainty of devices that pass a calibration, but also the incidence of out-of-tolerance calibrations and their impact on results.
Determine the reliability of devices
By brand
By model
By laboratory
By operator
Among peers
Determine best practices for the lab based on actual data from the lab. Calibration interval, accuracy and precision tolerances, and maintenance schedules can be determined based on statistical risk analysis and comparison to peer labs.
Record every encounter with a device and combine the data from each encounter with other data and expert guidance to automate a meaningful impact study in the event of a failed calibration.

Operators who utilize liquid handling devices may be required to wear a badge (or similar pendant, pin, bracelet or ring) with sensors, and devices may need to be equipped with appropriate sensors. Those sensors can record data about the devices and the encounter through use of the Hitachi Business Microscope or similar technology. Alternatively, the sensors could be stationary like those of PrimeSense or similar technology. The data recorded by those sensors may include, but is not limited to:
The time of day, the duration and the location of the encounter
The unique identity of the device and of the operator
The nature of the encounter, including
Count of work cycles, count of aspirations and dispenses
Device temperature with +/− limits, limit override with permissions and override notification on calibration report
Force used when applying tips
Calibration, calibration verification, and interim performance verification activities performed
Routine maintenance activities performed
Pipette dropping or other use-related information, such as not replacing pipette in a vertical stand
Inventory management: Usage of tips and calibration reagent is monitored in real-time and restocked as needed
Snapshot data records of the aspirations and dispenses and the use of those snapshots to measure all the things that affect performance.
The period of the stroke, the time profile (i.e. how much time spent fully depressed, how much of a pause, etc.)
The angle of the pipette
The speed of depression and release of the plunger
Duration that the pipette was held in a hand
Immersion depth of pipette tip
The variability of the encounters from encounter to encounter
The values of analogous parameters are recorded for ALHS use, and if appropriately enabled ALHS-software is used, ALHS protocol parameters are captured by the system software.

The badge might be about the size of a standard name tag issued at a conference and weighs less than 50 grams and worn around the neck on a lanyard. Inside the badge may be one or more infrared transceivers, an accelerometer, a flash memory chip, a microphone, a wireless transceiver, and a rechargeable lithium-ion battery that allows the badge to operate for up to two days at a time. The sensors measure the body movements and voice level, as well as the ambient air temperature and illumination. It tallies body movements—including head nods, arm waving, stretching, finger pointing, and other nonverbal communication much as a pedometer counts a person's steps. That is, the accelerometer measures each motion in the x, y, and z axes. These data are used by the system 200 to track adherence to protocols, find productivity improvements and to locate root causes of failures. Before leaving the lab each day, an operator places the badge in a base station which recharges the battery and downloads the stored information. These measurements are transmitted to the database 130 for analysis and long-term storage. Periodically, the system 200 optionally provides operators with reports on the activities that are being monitored.

The system 200 securely consolidates data from a wide range of operational and enterprise sources:
Other software products
Calibration management software and databases
Operator qualification software and databases
Asset management software and databases
Network-aware pipettes and ALHS
Parameter sets from ALHS software
Machine-readable identification of devices
   21 CFR Part 11 compliance and integrity of enterprise software are maintained since the software includes electronic signatures and a full Audit Trail to record all transactions in which data are pushed to the other databases. For example, when the owner of a device makes a decision from the system 200 and that decision triggers the device to go out of service in other databases.

The database 130 is the primary storage of relevant data. Other software may read from and write to the database 130, subject to security measures for doing so. The software of the system is configured to satisfy the 21 CFR Part 11 stipulation of limiting system access to authorized individuals. Direct operator input and import of various data files formats, such as comma separated values (CSV) files, are available.

Customers have a variety of data sources and no two customers have the same set of sources. The system 200 uses custom configurations and additional fields to accommodate the differences between customers. An isolated intranet configuration is preferably used to provide the core features of the application—management of the liquid handling device inventory with integration between pipette and ALHS performance, financial, inventory and training systems. The software connects via the Internet to send information to service providers about a customer's device population in order to prepare for calibrations and other services. The Internet connection provides the customer with anonymous data aggregated from all customers to give a broader outlook on device management through comparison of results and performance to industry-wide statistics and best practices. As a result, the software may be customized for each installation. Installation of the system 200 for a particular user may begin with a Discovery phase in which specific equipment and operations requirements are determined and used to populate the database 130 as well as to activate or modify secondary submodules such as the secondary submodules identified herein. In the event it is desirable to establish a secure environment for deployment and use of the system, all users of the system 200 are assigned appropriate roles for their identity within the system. Predefined roles include Directors, Technicians and Administrators. The assigned roles determine who has access to each of the various features of Platform Software. Additional roles for people can be created with more granular control of feature availability, with the ability to establish groups with certain access permissions.

Generally, the data sources for populating the database 130 belong to one of these categories:
New calibrations, calibration verifications, and interim performance verifications
Legacy calibrations, calibration verifications, and interim performance verifications
Purchasing
Materials management and supply chain, asset inventory management and tracking
Asset tracking of physical location and compliance-process status
Personnel data for training, competency assessment & access control (Active Directory integration)
Aggregated data from the Internet
   The data sources for each category are located, analyzed and documented for the purpose of connection to the system 200. The analysis requires knowledge of the data stored in each system and expertise with liquid handling calibration data. The goal of the Discovery phase for data sources is to match required fields in the database 130 with data sources on the network. Each data category has its own specific set of data fields that correspond to typical data used by the software. Additional customized fields can be created to further expand the capabilities of analytics.

All liquid handling devices that will fall under supervision of the system 200 are cataloged. The characteristics of the population are analyzed. A set of data parameters are assigned that sufficiently describe each device in the population. Device parameters are entered into the database 130 through any combination of manual entry, data file import (CSV, XLS, etc.) or database query. Default device parameters are included in, but not limited to, the following list. The names of the parameters can be configured to match the preferences of device owners.
Asset Parameters
Asset ID Number
Owner with Contacts
Accounting codes; Revenue stream; cost center
Active Directory user
Typical contact information
Email
Phone
Address
Department
Laboratory (Room number)
Location (Bench, Drawer, Cabinet)
Usage Note
Descriptive Parameters
Manufacturer Serial Number
Model Name
Brand name
Model Line
Maximum Capacity with Units
Minimum Capacity with Units
Standard Uncertainty
Ranges with Units
Sensitivity Coefficient
Standard Uncertainty with % and +/−
Channel Count
Device Type
Interface to computer (SILA compatible)
Measurements and Units (Volume in μL with cubic expansion coefficient, Mass in mg, Relative humidity in %, etc.)
Calibration Capabilities
CMC (Calibration Measurement Capability)
Uncertainty
Ranges
Channels
Descriptive Note
History
Purchase price, date, source
Date entered into database
Maintenance types, dates, costs, time out of service; allow attachment of maintenance/repair documentation
Misuse log
Triggers parts and maintenance orders in management services software
Calibration, calibration verification, and interim performance verification data
Calibration, calibration verification, or interim performance verification ID
Time and Date
Operator
Environmental parameters
Volumetric results, statuses and statistics
Per channel status
Dilution Ratio
Calibration, Calibration Verification, and Interim Performance Verification Instruments
Calibration history of instrument
Calibration verification history of instrument
Standard measurement materials (incl. serial numbers and calibration history)
Serial numbers
Names
Plate reader type
Tips
Names
Notes entry
Manufacturer
Lot numbers
Electronic review of calibration
Void sample capability
Notes entry
Miscellaneous Notes and Comments from calibration and calibration verification
Photometric Metadata
Reagent lot codes and IDs, serial numbers, descriptions, densities, alternative solution profiles
Device temperature in ° C. with +/− limits, limit override with permissions and override notification on calibration report
Difference from ambient temperature with +/− limits, limit override with permissions and override notification on calibration report
Multichannel Metadata
Layout Configuration
Layout ID
Layout Description
Number of Channels
Plate Type
Direction (Left-to-Right or Top-to-Bottom)
Device Orientation (Vertical or Horizontal)
Statistical method(s) used for analysis of multichannel data
Gravimetric Metadata
Environmental conditions monitoring
Ambient temperature in ° C. with +/− limits, limit override with permissions and override notification on calibration report
Humidity in % with +/− limits, limit override with permissions and override notification on calibration report
Barometric pressure with dimensional units, +/− limits, limit override with permissions and override notification on calibration report
mm Hg
in Hg
kPa
hPa
mbar
bar
psi
torr
Z-factor correction & method
Liquid density
Air density
Evaporation blank intervals
Sample timer
Protocols
Protocol validation with version number, date & comments
Protocol Priority for rescheduling when multiple calibrations are assigned to a device
Calibration and calibration verification protocols
Calibration or calibration verification name
As-Found or As-Left (Optional: Only As-Found if passing)
Frequencies and reminder periods
Test Points with order (high-to-low or reverse)
Samples per Test Point
maximum
minimum
omit permission and reasons
Pass/Fail Limits and the statistical models used (for ALHS, per ISO IWA 15)
Inaccuracy or Trueness
Imprecision overall
Imprecision sample
Others
Color coding for failing data
Requirements for data review
Required metadata fields (see History for a more complete list of calibration, calibration
verification and interim performance verification metadata)
Maintenance Protocols
Functions
Description
Inaccuracy action limits
Imprecision-overall action limits
Imprecision-sample action limits
Costs
Notes
Decontamination Protocols
Functions
Notes
Costs

Additional device parameters can be added as can different types of devices. When adding new devices in the software, parameter fields and drop-down lists are populated with the most recent and most popular occurrences in the database. As the operator enters text, the list is filtered to provide the answers that match, with most recent and most popular selects listed first. The software seeks to encourage the operator to use similar and matching results in order to clarify the data set and minimize duplication. The list of popular and most recent selections can be edited.

Security requirements are determined based on organizational policies, usually set forth by IT, QA/QC, and other managers.

Access control requirements are recorded for:
Local PCs, terminals, and mobile devices
Intra-network
Servers
Internet
Cloud storage
Updates
Aggregate data for analysis
News & Notes
Software updates
Software function permissions
administrator
operator
manager
reviewer
Password requirements are determined, usually comprising enforcement of some of:
complexity
expiration
length
history
biometrics
key cards
Windows & Active Directory integration
lockout on failed logon attempts
Electronic signatures system configuration
Signature components
Operator ID, retention time
Password
Graphic
Operations that call for a signature
Duration between full signature including Operator ID Notification System
Set notification modes based on type of notification and user level

The system 200 with such information acquired may be configured for functional operation. The following items form the framework for use of the software associated with the system 200 to effect optimal liquid handling device quality assurance in a convenient and cost effective manner.
Hardware set up
Workstation computers, mobile devices
Calibration hardware
On-site server
Software Installation
System software
Intranet Cloud
Connection to system cloud
Cloud-based storage
Anonymous aggregation across many customers
Analytical processing software
External data systems connections & importing
Data field mapping through construction of queries
Platform data aggregation
Create identities and set permissions for People
Custom screen setup from viewpoint templates
Custom report creation
Validation Plans
Expert services for Verification & Validation
Documentation assistance
Deployment of experts as needed
In person and on line expert services for training on the Platform

Customized pages of the dashboard reflect the various viewpoints held by operators of the system 200. A manager's viewpoint can have focus on device performance, cost of ownership, and employee certification. A trainer's viewpoint can have focus on performance of operators. Other common viewpoints include System Administrator, Materials Manager, Pipette and ALHS Operators and Quality Assurance Manager. The software is configured to show the right information to viewers based on their viewpoint. The following list of information shown in the default templates is for the standard set of viewpoints, and can be customized.

### System Administrator Functions

Installation Process
Setup New Operator Identities
Configure New Modules
Connect New Data Sources
Import Data
Set up and configure new devices (calibration plans, schedules, tolerances, etc.)
Set up and configure new pipette and ALHS operators for training and competency assessments

### Pipette/ALHS Operator Functions

### Pipette Operators and Supervisors

Misplace Device
Use Device in Process
Locate Device
   Maps and floor plans of the customer's entire campus
   Location data may be presented on a map
Check Supplies
   Identify the tips that are approved or best-suited for use with each device model
Misuse Device
Use of Supplies
Calibrations
Calibration Verifications
Interim Performance Verifications (Quick Performance Checks)
Associate device with performed laboratory work
Request Service
   Process PM and Repair Service details, reports, logs.
   Remove device from active service, then return it.
File Incident Reports
Replace device or parts from stockroom
Investigate:
   Performance by brand and model of device
   Performance and records of a specific device
   Personal training records

### ALHS Operators and Supervisors

Use Device in Process
Check Supplies
   Identify the tips that are approved or best-suited for use with each device model
   Tip racks, sample containers, tubes, racks
   Microplates and covers
Use of Supplies
Calibrations
Calibration Verifications
Interim Performance Verifications (Quick Performance Checks)
Associate device with performed laboratory work
Request Service
   Process PM and Repair Service details, reports, logs.
   Remove device from active service, then return it.
File Incident Reports
Replace parts from stockroom
Investigate:
   Performance by brand and model of device
   Performance and records of a specific device
   Personal training records
      Service Providers (for any device)
Locate Device
   Location data may be plotted in a bar graph to show which pipettes have to walk the farthest to be calibrated, or
   Used in an efficiency program that tells the calibration service the most efficient route to pick up the pipettes for service.
Configure Devices in System
As Found Verification
Service and Maintenance
Calibration
Tag for remote ID
Return device to Service, including all relevant certificates
Invoicing, purchase order management
View calibration process status
Predict:
   Number of channels due for calibration
   Reagent quantity needed for upcoming calibrations
Automated billing of service records.
Inventory, Purchasing & Accounts Receivable connections on the dashboard

### Director Functions

### Finance

Scorecards
Process Costs
Traditional Reporting
Pattern Discovery
Trend Analysis
Analytics, Data mining & exploration
Total Cost of Ownership of Pipettes
   Above the line hard costs
      Pipette purchase price
      Calibration cost per event
      Tips costs
      PM Parts Costs
         O-rings
         Lubrication
         Piston
         Seals
         Tip cones
         Tip Ejectors
         Batteries
         Other
      Repair & Maintenance Costs
      Service charges
      User training
   Below the surface soft costs
      Time and labor cost required to implement pipette quality program
      Time and labor cost to identify and qualify service vendors
      Logistics to gather, decontaminate, ship, and redistribute pipettes for calibration
      Shipping costs
      Maintenance of duplicate or triplicate pipette sets for use while one set is calibrated or serviced
      Time and labor costs due to delays in returning devices from calibration or service event; or due to incomplete returned documentation.
      Documentation for regulatory compliance
      Costs associated with audits
         Record keeping
         Impact of findings of incomplete records during audits
      Administration costs required for multiple purchase requisitions
      Time and labor to follow-up incomplete documentation
      As-found failure impact costs—to evaluate and document root causes of failure and to perform remedial follow up assessments
      Staff time spent calibrating
      Time spent on qualifying staff for calibration events
      Maintenance of calibration equipment
      Calibration supplies: Gloves, wipes, uniforms, lab coats, etc.
      Lack of Reliability
      Less reliability means
         increased maintenance cost
         cost associated with repeat of inconclusive or questionable work
      Pipette Performance—Reduced performance regarding accuracy and precision can impact the integrity of test results, especially for critical use pipettes
      Poor correlation in test methods from lab to lab
      Repeat testing
      Lack of transferability
      Health and safety
      Costs associated with addressing repetitive motion injury
   Upcoming costs:
How much will it cost to keep the device in service?
What calibration and training costs are predicted?
How Much Have I Saved with the system 200 when compared to past model?

An example of content that may be used in considering the value of using the system 200 compared to prior mechanisms employed for liquid handler quality assurance provides a Total

Cost of Ownership analysis in which the following is considered:
Above the line hard costs
   ALHS purchase price
   Additional dispense heads or liquid transfer modules
   Cost per calibration or performance verification event
   Cost for automation engineer to program the instrument (this person is different from the scientist using the ALHS for tests and assays)
   Tips costs
   Other consumables costs (tubes, racks, system fluid, etc.); highly variable depending on ALHS type.
   Parts Costs
      Replacement heads or parts thereof
      Replacement liquid transfer modules or parts thereof
      O-rings and seals
      Valves
      Motors
      Pumps
      Liquid lines
      System liquid
      All other parts
   Repair & Maintenance Costs
      Cost for automation engineer to perform routine maintenance
      Third-party of manufacturer service and repair
   Service contracts with ALHS manufacturer to service organization
   User training
Below the surface soft costs
   Time and labor cost required to implement liquid handling quality program
   Time and labor cost to identify and qualify service vendors
   Cost of down-time of the ALHS
      Lost analytical time
      Idle scientists or staff members
   Documentation for regulatory compliance
   Costs associated with audits
      Record keeping
      Impact of findings of incomplete records during audits
   Administration costs required for purchase requisitions for outside vendors (manufacturer or service organization)
   Time and labor to follow-up incomplete documentation
   As-found failure impact costs to evaluate and document root causes of failure and to perform remedial follow up assessments
   Staff time spent on calibration or interim performance verification
   Maintenance of calibration equipment
   Calibration supplies: Gloves, wipes, uniforms, lab coats, etc.
   Lack of Reliability
   Less reliability means
      increased maintenance cost
      cost associated with repeat of inconclusive or questionable work
   Poor correlation in test methods from lab to lab
      Cost of repeat testing
   Lack of transferability
Upcoming costs:
How much will it cost to keep the device in service?
What calibration and training costs are predicted?
How Much Have I Saved with the system 200 when compared to past model?

### Materials Management

Platform Insight
Traditional reporting
Inventory Management
Materials selection
   Vendor Performance
   Released from selecting devices
   no need to learn terminology
   with the lack of standards, comparison is difficult
Total Cost of Ownership analysis
Track the maintenance costs by department/operator and by device manufacturer/model.
Mean Time between failures
   In-service/down time by device
Savings from system 200
Supply Run Rate
Cost of system 200 with Lease Program

### Quality Assurance

Compliance Dashboard to provide quick, visual assurance that records are audit-proof
Device Failure Rate compared across all relevant data
Traditional reporting
Configuration Control
Assign Corrective Actions (Triggers parts and maintenance orders in management services software)
Assure that the proper tips are being used
Identify Devices that are:
In Service
Pending
Overdue
Out of Calibration
In Process
Inspected
As Found
Calibrated
Retired
See the details broken down by department, pipette operator or other parameters
Identify how many pipettes have failed within a specified time frame to determine failure rates by department/operator and by manufacturer/model or calibration interval. The intent is to help identify the most and least reliable pipettes to weed out the poor performers and cultivate the best performers.
Identify staff member training, competency assessments, and certification status.

### Process Control

Traditional reporting and analytics
Process Revision and Process Improvement
Process risk assessment and prediction based on analytics and input parameters
Implement best liquid handling practices for each process
Implement appropriate calibration and interim performance verification steps.
Ensure the proper pipettes/ALHS for the task being used in each department, including proper consumables and operational methods and techniques.
Assist with measurement uncertainty (MU) calculations for liquid handling
Assist with overall process MU calculations
Determine if certain pipette/ALHS models will perform better under specific process conditions.
Assist with Method Development
Assist with Method Transfer
Evaluate environmental impact on process performance
Ensure operators are trained in and apply best practices for a particular process.
People
Training records and tools
Traditional reporting and analytics to track technique training status of technical staff
Skills Assessment
Documented competency assessments for compliance with regulatory and organizational requirements
Resource Allocation
Upcoming training needs
Identify the pipettes and ALHS that perform the best in terms of precision and accuracy. Compare this type of performance data by department/operator to see where training would be most helpful.

Having thus described at least one illustrative embodiment of the invention, various alterations, modifications and improvements are contemplated by the invention. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A system implemented at least in part by a computing system configured to carry out executable instructions using computer-implemented functions to improve operation of the computing system to enable maintenance of one or more liquid handlers, the system comprising:
a. a database of information including information associated with an inventory of new and used liquid handlers;
b. an inventory management and analytics module operable on the computing system in communication with the database, configured to manage the inventory of new and used liquid handlers and to analyze information from the database and other sources for performance characteristics;
c. an instrument control module operable by the computing system in communication with the database and configured to transmit and receive information associated with operation of the one or more liquid handlers to the database for use by the inventory management and analytics module; and
d. a maintenance module operable by the computing system in communication with the database, the instrument control module and one or more sensors, wherein the maintenance module is configured to carry out calibration of the one or more liquid handlers and transmit such information to the database for use by the inventory management and analytics module,
wherein the inventory management and analytics module is configured to gather information associated with the liquid handlers from the database, the instrument control module and the maintenance module, recognize patterns of performance of the one or more liquid handlers, analyze patterns of performance and develop information from that analysis to estimate cost of operations and to assess the efficiency of processes and operations associated with the one or more liquid handlers.

2. The system of claim 1 further comprising a method module operable by the computing system and configured to enable liquid handler to liquid handler exchanges, tip determination and scale-up assistance.

3. The system of claim 1 wherein the inventory management module includes a physical asset tracking and utilization submodule and a reagents and consumables submodule.

4. The system of claim 1 wherein the instrument control module is configured to conduct online and offline liquid handler measurements with feedback to the database and the inventory management module.

5. The system of claim 1 wherein the maintenance module is configured to conduct calibration and performance verification, proactive and preventive maintenance, scheduling, and provide repair instructions and parts identification.

6. The system of claim 1 further comprising a training module operable by the computing system in communication with the database and configured to supply instructional lessons on liquid handler operation and to conducting testing of liquid handling systems operator proficiency wherein such information can be used to control permission of use of the one or more liquid handlers.

7. The system of claim 1 wherein the one or more liquid handlers are selected from the group comprising automated liquid handling systems and pipettes.

8. The system of claim 1 further comprising an inventory of liquid handlers, reagents and consumables, wherein information associated with the inventory is maintained in the database.

9. A method implemented at least in part by a computing system configured to carry out executable instructions using computer-implemented functions to maintain one or more liquid handlers, the method comprising the steps of:
a. establishing and updating a database of information including information associated with an inventory of new and used liquid handlers;
b. managing the inventory of new and used liquid handlers;
c. transmitting and receiving information to and from the one or more liquid handlers and the database associated with operation of the one or more liquid handlers; and
d. analyzing the information from the database, the inventory management and other sources to recognize patterns of performance of the one or more liquid handlers, analyze patterns of performance and develop information from that analysis to estimate cost of operations and to assess the efficiency of processes and operations associated with the one or more liquid handlers.

10. The method of claim 9 further comprising the step of calibrating the one or more liquid handlers and transmitting to the database information associated with the calibration.
